(19) United States
(12) Patent Application Publication
(10) Pub. No.: US 2008/0074332 A1
(43) Pub. Date: Mar. 27, 2008

(54) Multilevel Ground-Plane for a Mobile Device

(76) Inventors: Alfonso Sanz Arronte, Barcelona (ES); David Gala Gala, Barcelona (ES); Antonio Condes Martinez, Barcelona (ES); Carles Puente Baliarda, Barcelona (ES)

Correspondence Address: WINSTEAD PC, P.O. BOX 50784, DALLAS, TX, 75201, US

(21) Appl. No.: 11/662,044

(22) PCT Filed: Sep. 20, 2005
(86) PCT No.: PCT/EP05/10131

§ 371 Date: Sep. 11, 2007

Related U.S. Application Data
(60) Provisional application No. 60/611,889, filed on Sep. 21, 2004.

(51) Int. Cl. H01Q 1/24; H01Q 1/38

(52) U.S. Cl. 343/702; 343/700 MS

(57) ABSTRACT

In accordance with the teachings described herein, a multilevel ground-plane for a mobile device is provided. The multilevel ground-plane includes a first conductive surface, a second conductive surface, and a conducting strip that couples the first conducting surface to the second conducting surface. A mobile device having a multilevel ground-plane may include a printed circuit board, an antenna radiating element attached to a surface of the printed circuit board, and the multilevel ground plane integral with the printed circuit board and electromagnetically coupled to the antenna radiating element.

### FIELD

The technology described in this patent document relates generally to antennas. More specifically, this document describes antenna ground-planes having multilevel structures, which are particularly well-suited for use as the ground-plane in miniature and multiband antennas in a mobile device, such as a cellular telephone.

### BACKGROUND

In many antenna applications, such as mobile devices (e.g., cellular telephones, PDAs, pagers, etc.), the size of the device may restrict the size of the antenna and its ground-plane, which may effect the overall antenna performance. For example, the bandwidth and efficiency of the antenna may be affected by the overall size, geometry, and dimensions of the antenna and the ground-plane. A report on the influence of the ground-plane size in the bandwidth of terminal antennas can be found in the publication “Investigation on Integrated Antennas for GSM Mobile Phones”, by D. Manteuffel, A. Bahr, I. Wolff, Millennium Conference on Antennas & Propagation, ESA, AP2000, Davos, Switzerland, April 2000.

### SUMMARY OF THE INVENTION

In accordance with the teachings described herein, a multilevel ground-plane for a mobile device is provided. The multilevel ground-plane includes a first conductive surface, a second conductive surface, and a conducting strip that couples the first conducting surface to the second conducting surface. A mobile device having a multilevel ground-plane may include a printed circuit board, an antenna radiating element attached to a surface of the printed circuit board, and the multilevel ground plane integral with the printed circuit board and electromagnetically coupled to the antenna radiating element.

Another aspect of the invention refers to an antenna system or an antenna device, which comprises a radiating element placed over a ground plane, wherein the radiating element has at least one edge and the ground plane has at least one slot, so that at least a part of one edge of the radiating element is positioned over a part of one slot of the ground plane. This particular arrangement of the radiating element and the ground plane, improve the performance of the antenna.

A further aspect of the invention, refers to a radiating element or an antenna which comprises at least one hole defining an empty area on said radiating element, wherein the shape of said empty area is formed by polygonal shapes connected or overlapping at a contact region of their perimeter, wherein the contact region between directly connected polygonal shapes is narrower than 50% of the perimeter of said polygonal shapes, and wherein the polygonal shapes have the same number of sides but not all the polygonal shapes have the same shape. This radiating element or antenna, may be used in the above described antenna system.

A further aspect of the invention refers to a mobile communications device which comprises the above described antenna system. The communication device may consist for instance in a cellular telephone, a PDA, or a pager.

### BRIEF DESCRIPTION OF THE DRAWINGS

FIG. 1.—shows an example multilevel ground-plane for an antenna.

FIG. 2.—illustrates a number of example space-filling curves that may be included in a multilevel ground-plane.

FIG. 3.—illustrate examples of planar inverted-F antenna (PIFA) structures. FIG. 3A is an example of the prior art, and FIG. 3B is an example according to the present invention.

FIG. 4.—illustrate examples of monopole antenna structures. FIG. 4A is an example of the prior art, and FIG. 4B is an example according to the present invention.

FIG. 5.—illustrate another example antenna configuration. FIG. 5A is an example of the prior art, and FIG. 5B is an example according to the present invention.

FIG. 6 to FIG. 18.—illustrate several additional examples of geometries for multilevel ground-planes.

FIG. 19.—shows two perspective view of examples of antenna structures in which the radiating element is shaped similarly to the multilevel ground-plane.

FIG. 20.—shows a perspective view of an antenna system for a mobile device, wherein only one part of the printed circuited board has been represented.

FIG. 21.—shows the same view of FIG. 20 with the radiating element spaced apart from the ground plane.

FIG. 22.—shows a perspective bottom view of an antenna system for a mobile device of FIG. 21.

FIG. 23.—shows in FIG. 23a a top plan view of the embodiment of FIG. 20. FIG. 23b shows a side view, and FIG. 23c is a bottom plan view of the same figure.

FIG. 24 and FIG. 28.—show a similar view than the one on FIG. 20.

FIG. 25 and FIG. 29.—show a similar view than the one on FIG. 21.

FIG. 26 and FIG. 30.—show a similar view than the one on FIG. 22.

FIG. 27 and FIG. 31.—show a similar view than the one on FIG. 23.

FIG. 32.—shows a similar view than the one on FIG. 20.

FIGS. 33.—shows in perspective the bottom face of an example of antenna for a mobile device, wherein other mobile device components are mounted on a surface of the printed circuit board opposite the radiating antenna element.

### DETAILED DESCRIPTION

Multilevel ground-planes, as described herein, are an integral part of the antenna structure, and contribute to the radiation and impedance performance of the antenna (e.g., impedance level, resonant frequency, bandwidth.) That is, the antenna ground-plane is shaped to force the ground-plane currents to flow and radiate in such a way that the combined effect of the ground-plane and the radiating element enhances the performance and characteristics of the whole antenna device (e.g., bandwidth, VSWR, multiband behaviour, efficiency, size, gain.) This is achieved by breaking the solid surface of the antenna ground-plane into a plurality of conducting surfaces that are electromagnetically coupled by the capacitive effect between the edges of the several conducting surfaces, by a direct electrical contact through one or more conducting strips, or by a combination of both. This ground-plane structure may be formed by including a multilevel geometry in at least a portion of the ground-plane. In addition, the multilevel ground-plane geometry may include one or more space-filling curves, as described below.

For the purposes of this patent document, a multilevel ground-plane geometry includes a conducting structure including a set of polygons, all of said polygons featuring the same number of sides, wherein said polygons are electromagnetically coupled either by means of a capacitive coupling or ohmic contact, wherein the contact region between directly connected polygons is narrower than 50% of the perimeter of said polygons in at least 75% of said polygons defining said conducting ground-plane. In this definition of multilevel geometry, circles and ellipses are included because they can be understood as polygons with an infinite number of sides.

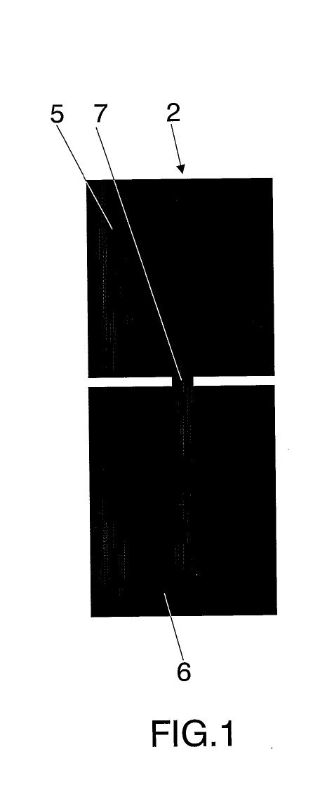

FIG. 1 shows an example multilevel ground-plane (2) for an antenna. The ground plane includes two conducting surfaces (5), (6) that are electrically connected by a conducting strip (7). The conducting surfaces (5), (6), in this example are electromagnetically coupled by the capacitive effect between adjacent edges and also by direct electrical contact through the conducting strip (7).

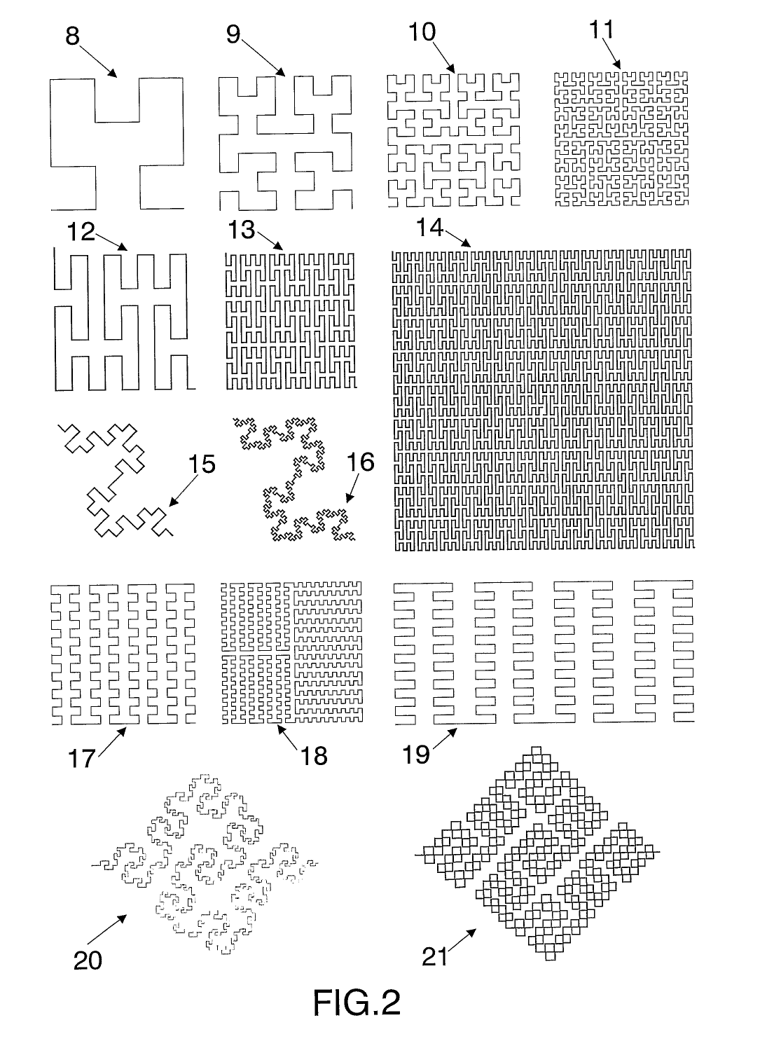

FIG. 2 illustrates a number of example space-filling curves (8-21) that may be included in a multilevel ground-plane. A space-filling curve (hereafter SFC) is a curve that is large in terms of physical length but small in terms of the area in which the curve can be included. More precisely, the following definition is taken in this document for a space-filling curve: a curve composed by at least ten segments which are connected in such a way that each segment forms an angle with adjacent segments, that is, no pair of adjacent segments define a larger straight segment, and wherein the curve can be optionally periodic along a fixed straight direction of space if, and only if, the period is defined by a non-periodic curve that includes at least ten connected segments and no pair of said adjacent and connected segments defines a straight longer segment. Also, the SFC can never intersect with itself at any point except the initial and final point (that is, the whole curve can be arranged as a closed curve or loop, but none of the parts of the curve can become a closed loop). A space-filling curve can be fitted over a flat or curved surface, and due to the angles between segments, the physical length of the curve is always larger than that of any straight line that can be fitted in the same area (surface) as said space-filling curve. Additionally, to properly shape the ground-plane, the segments of the SFC curves included in said ground-plane should be shorter than a tenth of the free-space operating wavelength.

Depending on the shaping procedure and curve geometry, some infinite length SFC can be theoretically designed to feature a Haussdorf dimension larger than their topological-dimension. That is, in terms of the classical Euclidean geometry, it is usually understood that a curve is always a one-dimension object; however when the curve is highly convoluted and its physical length is very large, the curve tends to fill parts of the surface which supports it; in that case, the Haussdorf dimension can be computed over the curve (or at least an approximation of it by means of the box-counting algorithm) resulting in a number larger than unity. The curves described in FIG. 2 are some examples of such SFC; in particular, drawings 11, 13, 14, and 18 show some examples of SFC curves that approach an ideal infinite curve featuring a dimension D=2. As known by those skilled in the art, the box-counting dimension can be computed as the slope of the straight portion of a log-log graph, wherein such a straight portion is substantially defined as a straight segment. In this case, said straight segment should cover at least an octave of scales on the horizontal axis of the log-log graph.

Referring again to FIG. 2, an initial SFC (8) is illustrated, from which other SFCs (9), (10), (11) may be formed (called Hilbert curves.). Likewise, other sets of SFCs may be formed from different initial SFCs, such as SFC set (12), (13) and (14) (called SZ curves), SFC set (15) and (16) (called ZZ curves), SFC set (17), (18) and (19) (called HilbertZZ curves), SFC (20) (Peanodec curve), and SFC (21) (based on the Giusepe Peano curve.)

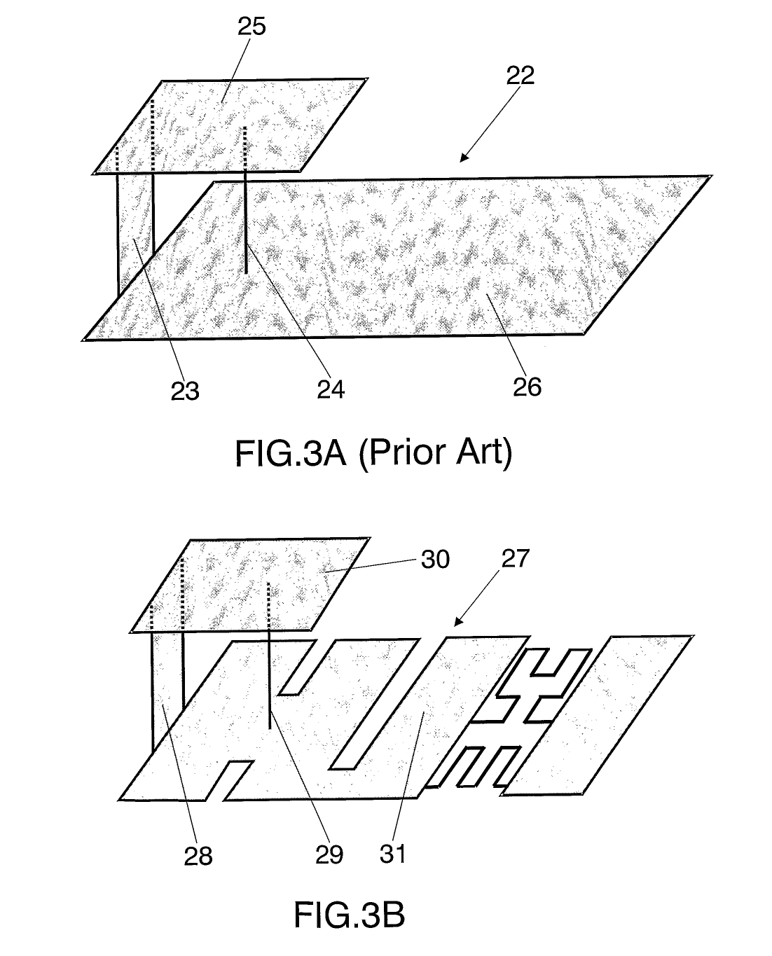

FIGS. 3B, 4B and 5B illustrate example antenna structures having multilevel ground-planes. The examples of FIGS. 3B, 4B and 5B are formed by modifying the ground-plane geometry of a conventional antenna design (3A, 4A and 5B, respectively). It should be understood that other antenna configurations could be similarly modified to include a multilevel ground-plane. In addition, novel antenna configurations could also be created using the multilevel and space-filling ground plane geometries, as described herein.

FIGS. 3A and 3B illustrate example planar inverted-F antenna (PIFA) structures. FIG. 3A shows a perspective view of a typical PIFA structure (22), and FIG. 3B shows a perspective view of a PIFA structure (27) having a multilevel ground-plane (31). With reference first to FIG. 3A, the conventional PIFA structure (22) includes a radiating element (25), a solid surface ground-plane (26), a feed point (24) coupled somewhere on the radiating element (25) (depending upon the desired input impedance), and a short-circuit (23) coupling the radiating element (25) to the ground-plane (26). The feed point (24) can be implemented in several ways, such a coaxial cable, the sheath of which is coupled to the ground-plane (26) and the inner conductor (24) of which is coupled to the radiating element (25). The radiating element (25) is usually shaped like a quadrangle, but other geometries are also possible. The shape and dimensions of the radiating element (25) will contribute in determining operating frequency of the overall antenna system. The ground-plane size and geometry also has an effect in determining the operating frequency and bandwidth for the PIFA.

In the example of FIG. 3B, the ground-plane (31) includes a multilevel structure. More particularly, the example PIFA (27) shown in FIG. 3B includes a radiating antenna element (30), a multilevel ground-plane (31), a feed point (29) coupled somewhere on the radiating antenna element (30), and a short-circuit (28) coupling the radiating antenna element (30) to the ground-plane (31). The example multilevel ground-plane (31) shown in FIG. 3B includes several quadrangular surfaces that are electromagnetically coupled by means of direct contact through conducting strips, and another quadrangular surface coupled by direct contact through a SFC and a meandering line. More precisely, the ground-plane (31) includes a multilevel structure formed from 5 rectangles, said multilevel structure being connected to a rectangular surface by means of SFC (8) and a meandering line with two periods. The surfaces of the example ground-plane are lying on a common flat surface, but other conformal configurations upon curved or bent surfaces could also be used. The edges between coupled rectangles in the illustrated ground-plane (27) are either parallel or orthogonal, but could be differently arranged in other embodiments.

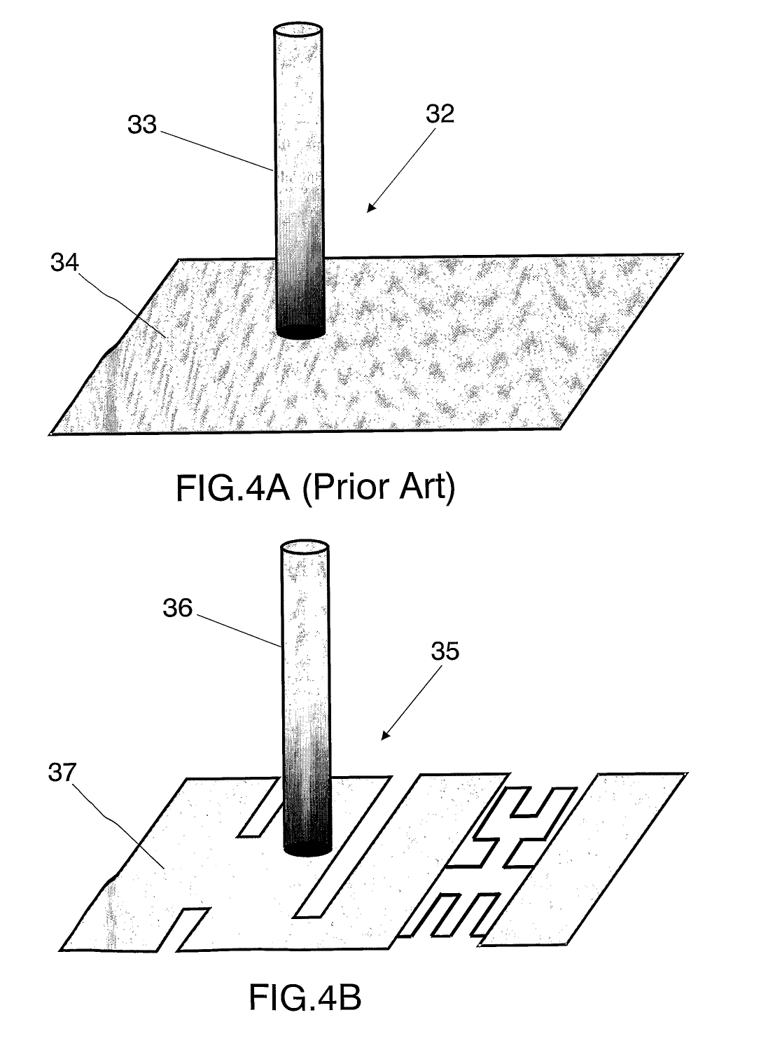

FIGS. 4A and 4B illustrate example monopole antenna structures. FIG. 4A shows a perspective view of a typical monopole antenna structure (32), and FIG. 4B shows a perspective view of a monopole antenna structure (35) having a multilevel and space-filling ground-plane (37). More particularly, the conventional monopole antenna structure (32) illustrated in FIG. 4A includes a radiating element (33) and a solid ground-plane (34). In the example of FIG. 4B, the monopole antenna structure is modified by replacing the solid ground plane (34) with a multilevel ground plane (37). The radiating arm (36), (33) in the illustrated embodiments is cylindrical, however other monopole radiating arm structures could also be used, such as helical, zigzag, meandering, fractal, SFC, or other configurations.

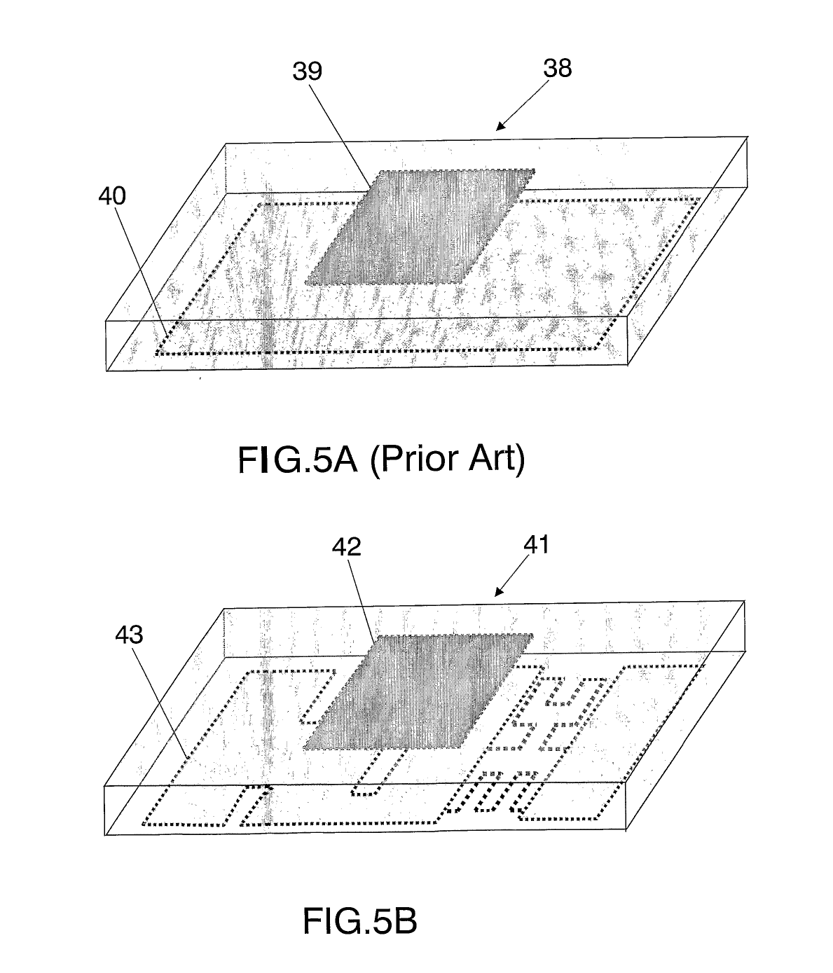

FIGS. 5A and 5B illustrate another example antenna configuration. FIG. 5A shows a typical patch antenna configuration (38), and FIG. 5B shows a patch antenna structure (41) having a multilevel ground-plane (43). The conventional patch antenna (38) shown in FIG. 5A includes a polygonal patch (38) (e.g., square, triangular, pentagonal, hexagonal, rectangular, circular, multilevel, fractal, etc.) and a solid ground-plane (40), both disposed on a dielectric substrate. The example patch antenna (41) shown in FIG. 5B includes a radiating element (42) (that can have any shape or size) and a multilevel ground-plane (43), both disposed on a dielectric substrate. The patch antenna (41) may, for example, be fabricated using etching techniques as used to produce PCBs, by printing the radiating element (42) and ground-plane (43) onto the substrate using a conductive ink, or by other conventional means. For example, a low-loss dielectric substrate (such as glass-fiber, a teflon substrate such as Cuclad® or other commercial materials such as Rogers® 4003) can be placed between the patch element (42) and the ground-plane (43). Different antenna feeding schemes for patch antennas can be used, for instance: a coaxial cable with the outer conductor connected to the ground-plane (43) and the inner conductor connected to the patch element (42) at the desired input resistance point; a microstrip transmission line sharing the same ground-plane (43) as the antenna with the strip capacitively coupled to the patch (42) and located at a distance below the patch, or alternatively with the strip placed below the ground-plane and coupled to the patch through an slot, a microstrip transmission line with the strip co-planar to the patch, or others.

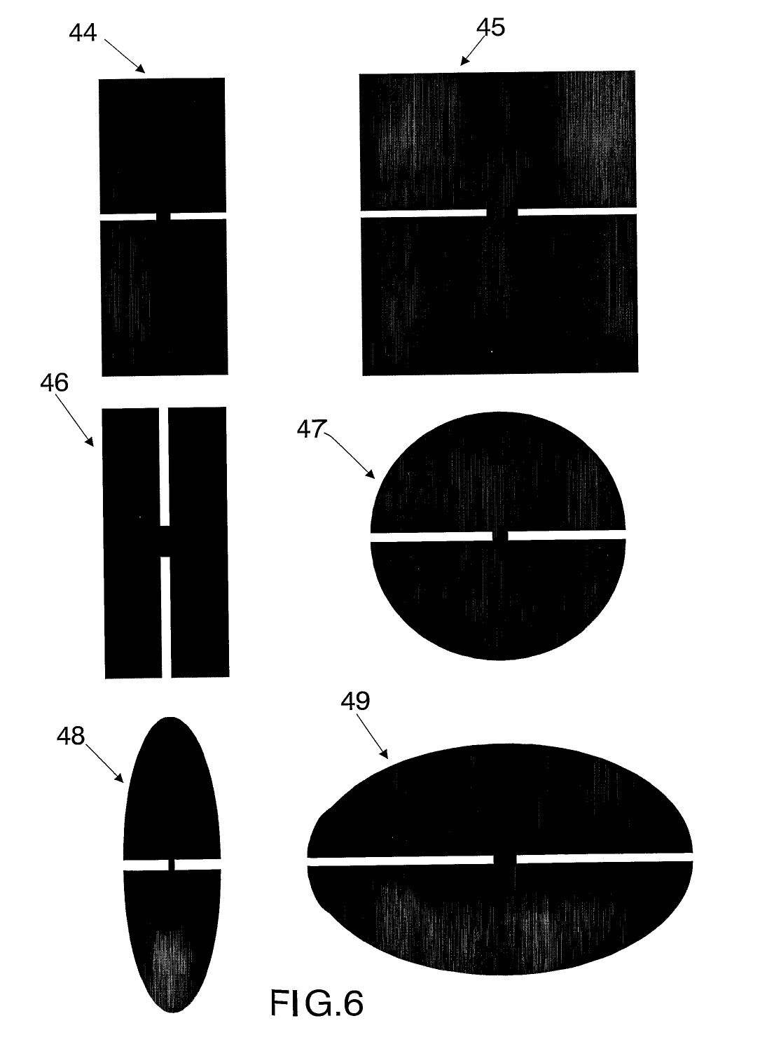

FIGS. 6-18 illustrate several additional example geometries for multilevel ground-planes. The ground-plane geometries shown in FIGS. 6-18 may, for example, be used in the antenna structures shown in FIGS. 3B, 4B and 5B, or may be used in other antenna structures.

FIG. 6 shows several examples of different contour shapes for multilevel ground-planes, such as rectangular (44, 45, and 46) and circular (47, 48, and 49). In this case, circles and ellipses are polygons with an infinite number of sides.

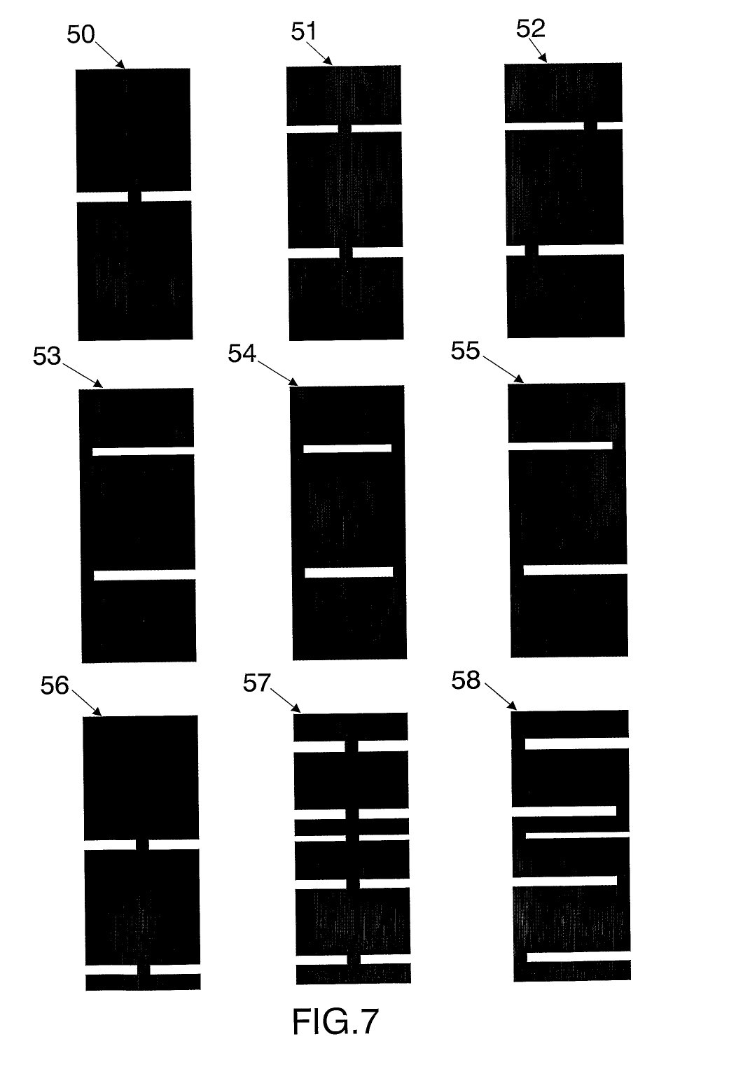

FIG. 7 shows a series of same-width multilevel structures (in this case rectangles), where conducting surfaces are being connected by means of conducting strips (one or two) that are either aligned or not aligned along a straight axis.

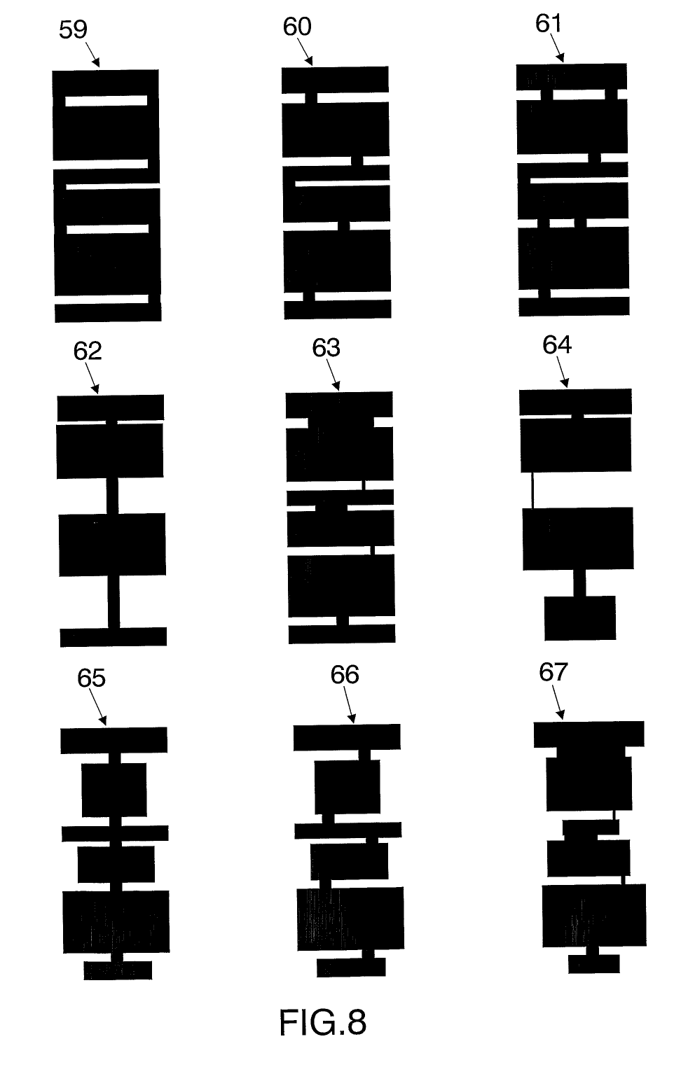

FIG. 8 shows additional example multilevel ground-plane geometries (59-67). As illustrated, a multilevel ground-plane may include conducting surfaces and conducting strips with varying lengths and widths. In addition, more than one conducting strips may be used to interconnect the conducting surfaces, as shown in geometries (59) and (61).

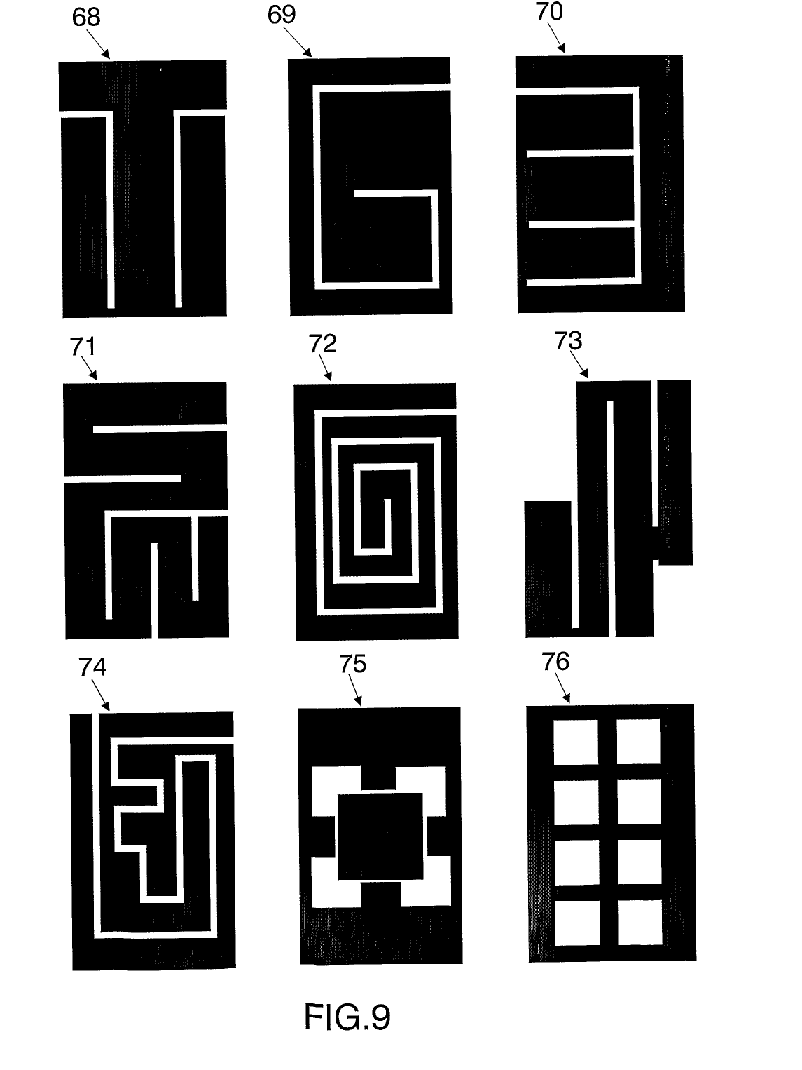

FIG. 9 shows several additional examples of multilevel ground-planes (68-76). The illustrated ground-plane examples (68-76) are formed from rectangular structures, however other shapes could be used.

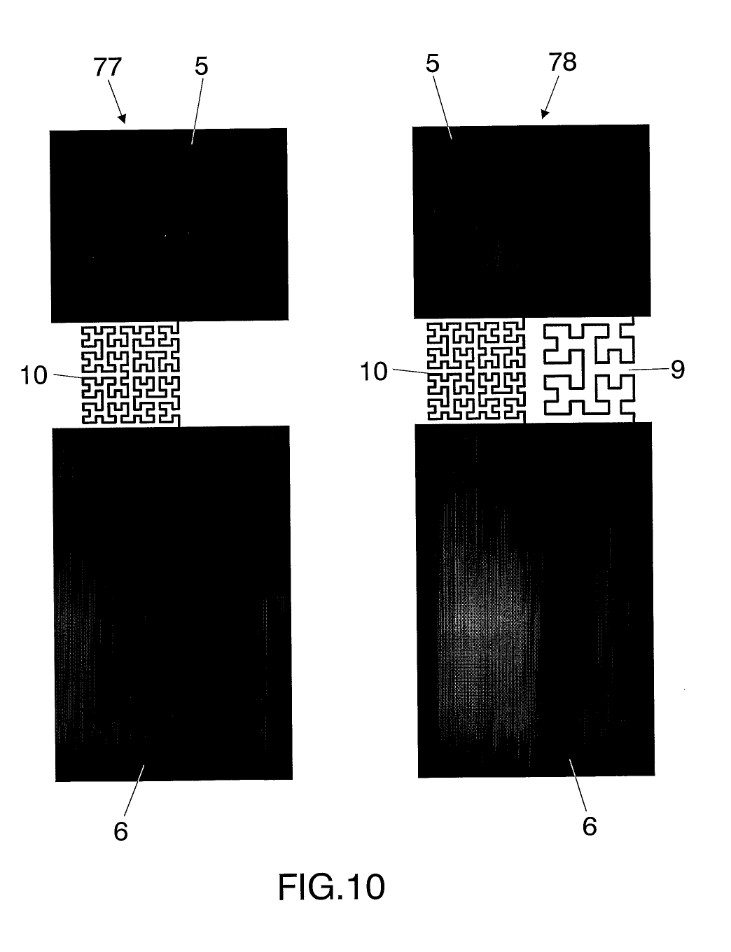

FIG. 10 shows two example multilevel ground-planes (77), (78). The illustrated ground planes (77), (78) both include two conducting surfaces (5), (6) that are connected by one or more SFCs (9), (10).

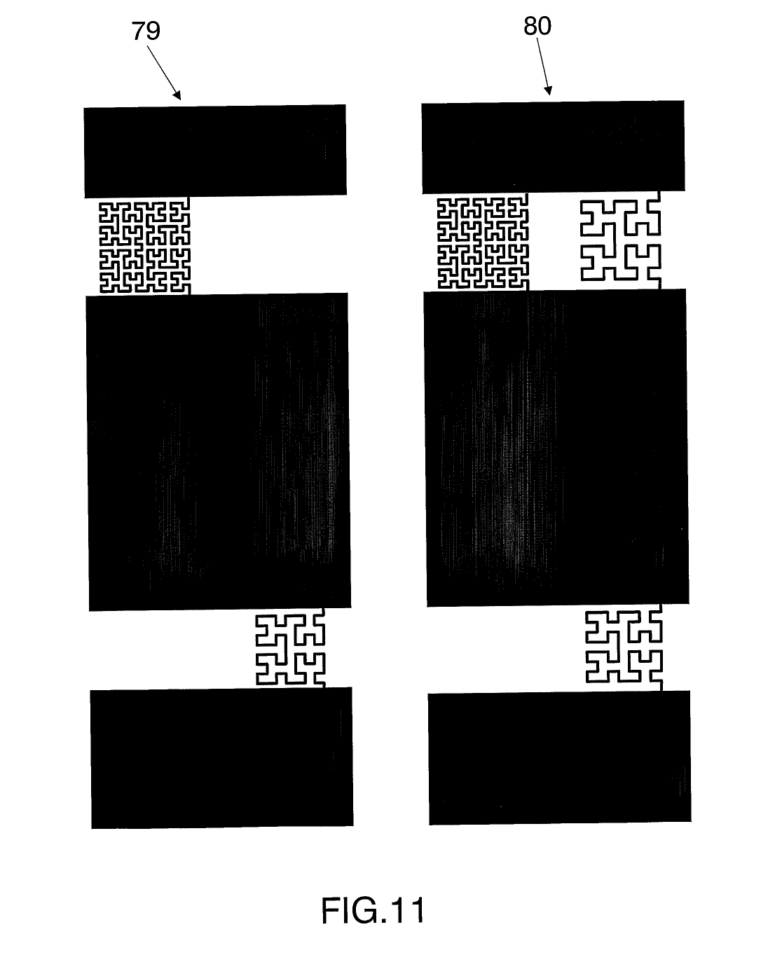

FIG. 11 shows two additional example multilevel ground-planes (79), (80). In these two examples, three conducting surfaces are connected with by one or more SFCs.

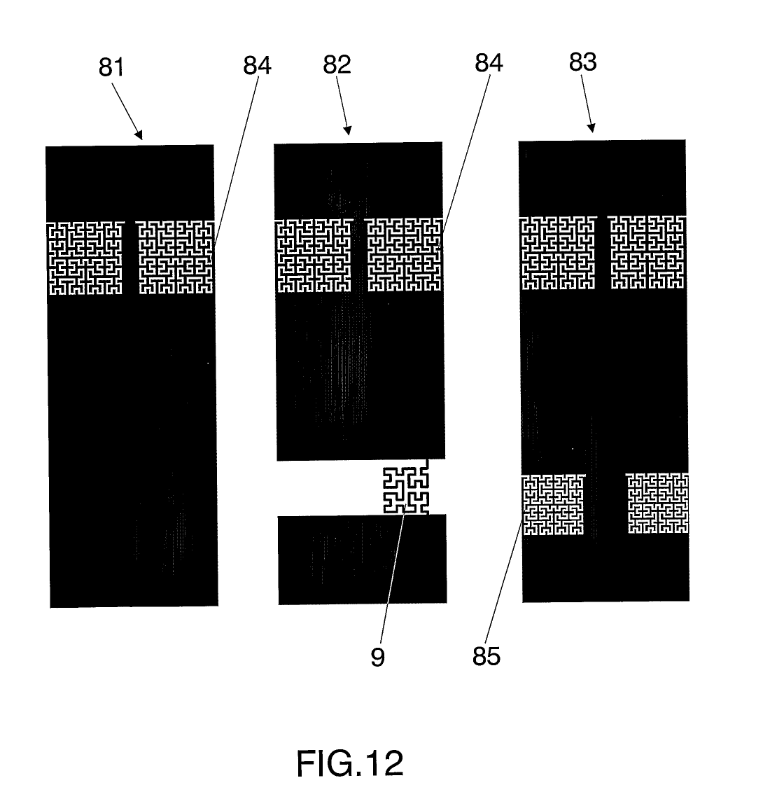

FIG. 12 shows three example multilevel ground-planes (81-83). In these examples, at least one of the gaps (84), (85) between conducting surfaces are shaped as SFCs. In particular, the gaps (84) and (85) between conducting surfaces are shaped as SFCs.

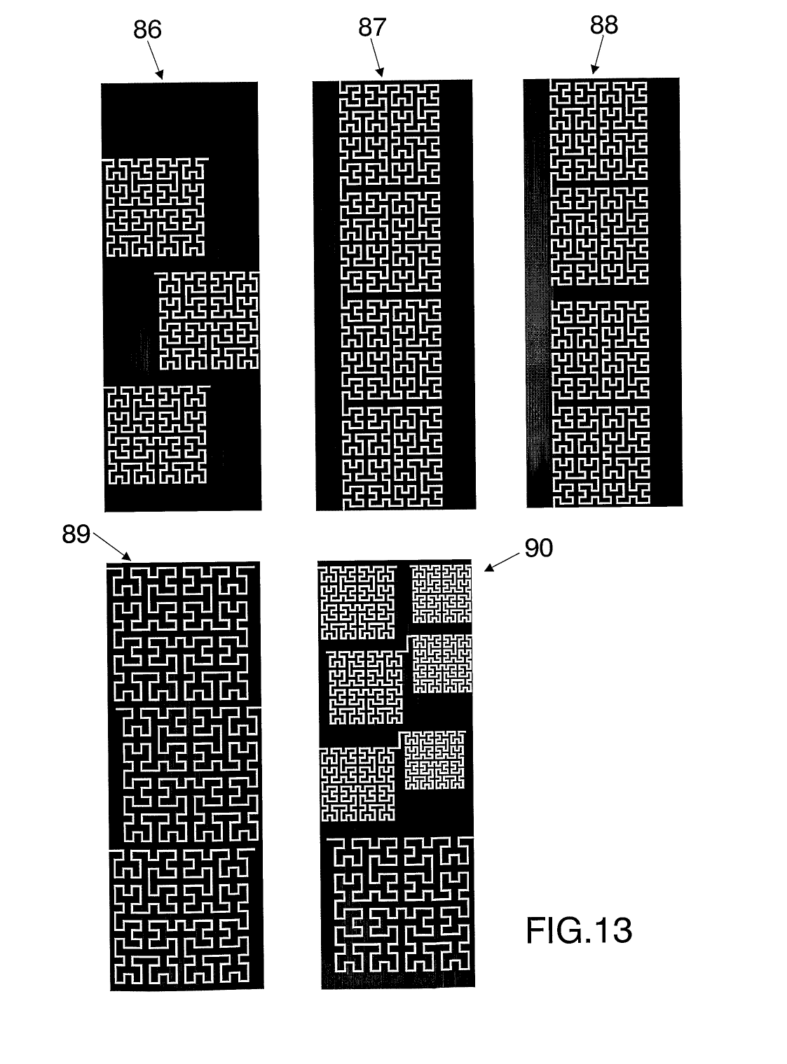

FIG. 13 shows another set of example multilevel ground-planes (86-90) in which portions of the ground-plane structure are shaped as SFCs.

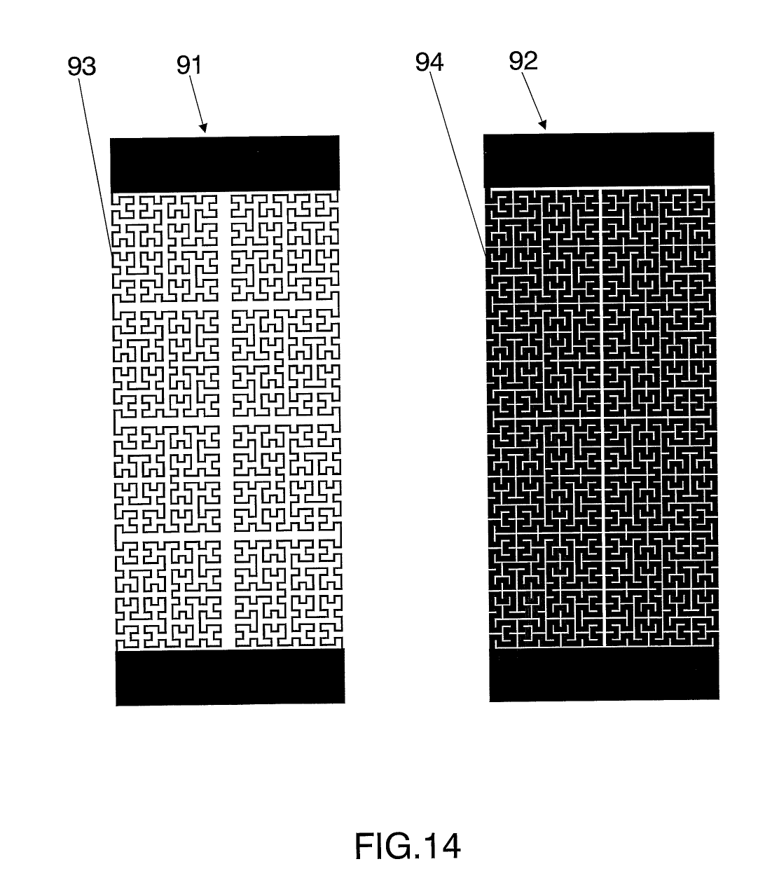

FIG. 14 shows two additional example multilevel ground planes (91), (92). Depending on the application, configuration (91) can be used to minimize the size of the antenna while configuration (92) may be used to enhance bandwidth in a reduced size antenna while reducing the backward radiation.

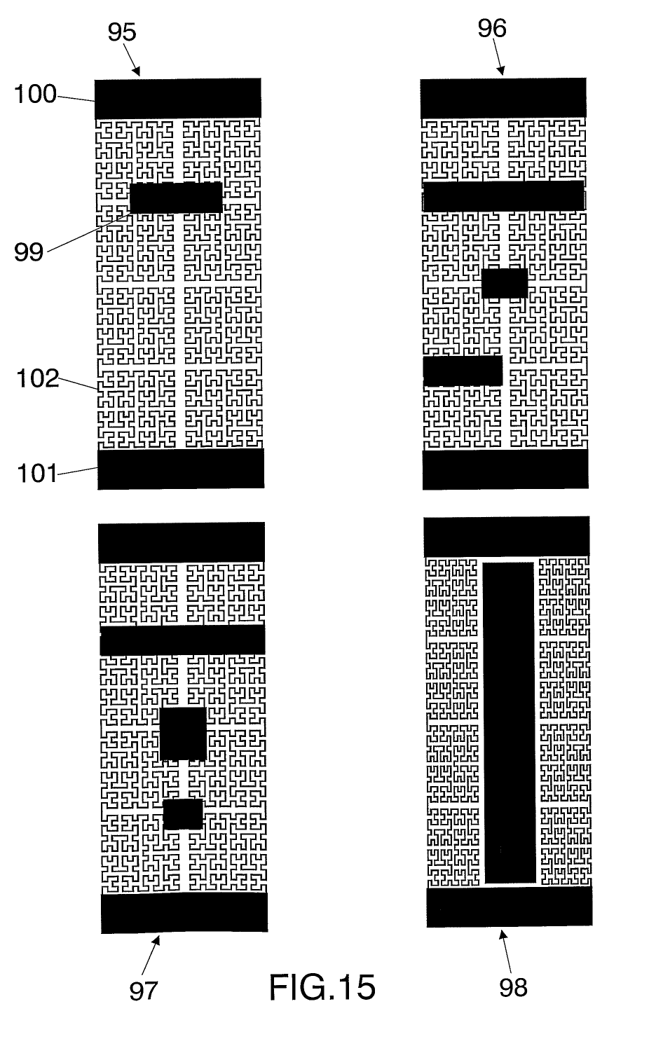

FIG. 15 shows another example set of multilevel ground planes (95-98). In these examples, conducting surfaces with different widths are connected by SFC conducting strips, either by direct contact (e.g., 95, 96, 97, 98) or by capacitive effect (e.g., the central strip in 98).

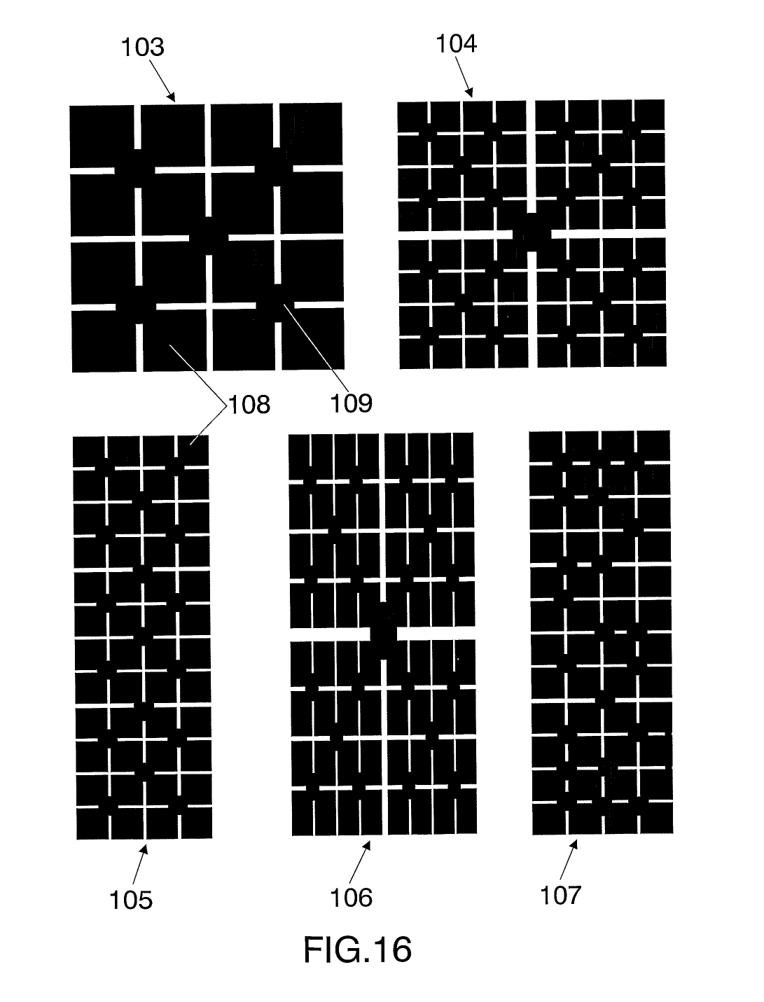

FIG. 16 shows several additional example multilevel ground-planes. The illustrated examples (103-107) are formed by rectangles, but could be formed from different shapes in other examples.

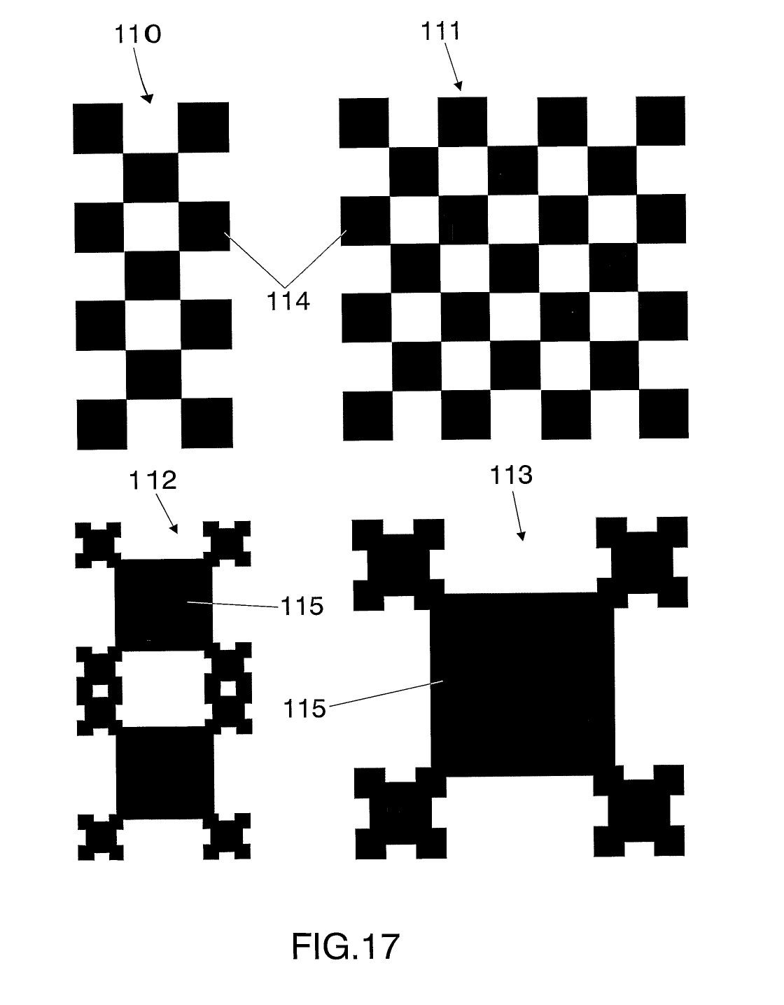

FIG. 17 shows four additional examples of multilevel ground-planes (110-113). In these examples, the ground-planes are formed by interconnected squares.

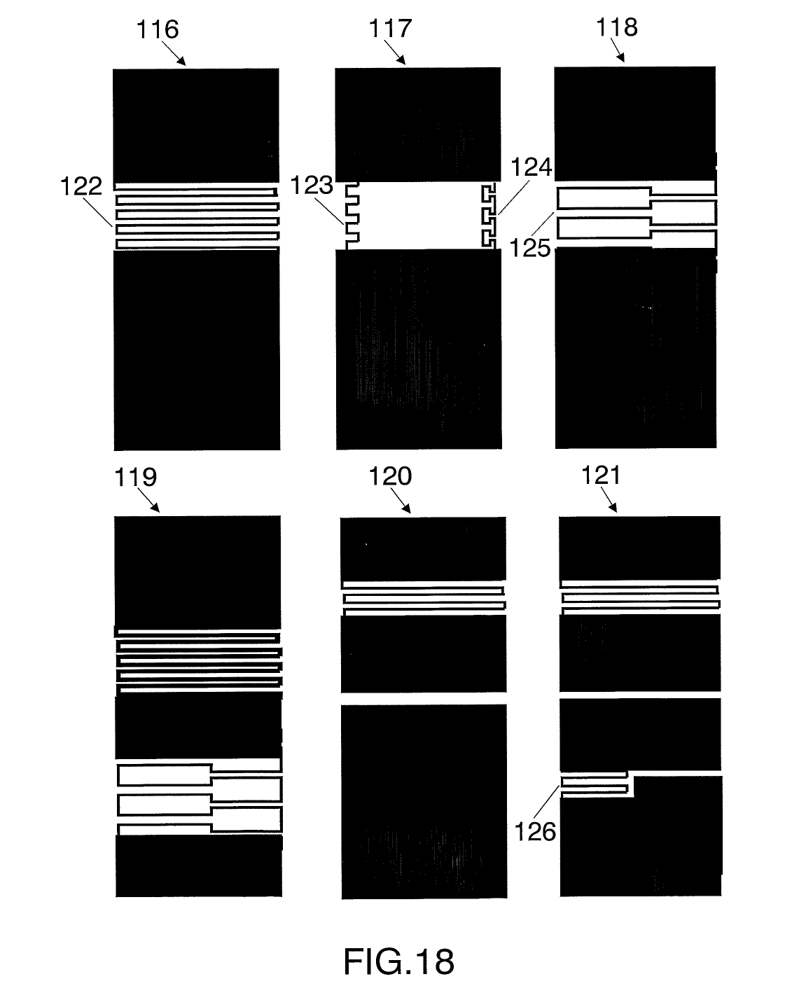

FIG. 18 shows examples (116-121) of multilevel ground-planes where at least two conducting surfaces are connected through meandering curves with different lengths or geometries. In other examples, one or more of the meandering lines could be replaced by SFCs. Replacing one or more meandering lines with SFCs may, for example, achieve a further size reduction or a different frequency behaviour of the antenna.

As illustrated in the examples described above, the conducting strip(s) connecting the surfaces of the ground-plane can be placed at the center of the gaps, as shown in FIG. 6 and ground-plane geometries (2, 50, 51, 56, 57, 62 and 65), or distributed along several positions as shown in other illustrations (e.g., 52 and 58.) In some examples, the conducting surfaces may have the same width (e.g., FIG. 1 and FIG. 7), but in other examples conducting surfaces with different widths may be used (e.g., drawings 64 through 67 in FIG. 8.) The conducting surfaces and/or conductive strips are linearly arranged with respect to a straight axis in some examples (e.g., 56 and 57), while in other examples they are not centered with respect to an axis. The conductive strips can also be placed at the edges of the overall ground-plane (e.g., geometry 55), or can become arranged in a zigzag or meandering pattern (e.g., geometry 58) where the strips are alternatively and sequentially placed at the two longer edges of the overall ground-plane.

In some examples, (e.g., 59 and 61), several conducting surfaces are coupled by means of more than one strip or conducting polygon. This geometry may be advantageous if a multiband or broadband behaviour is to be enhanced. Such multiple strip geometries allow multiple resonant frequencies which can be used as separate bands or as a broad-band if properly coupled. In addition, multiband or broad-band behaviour can be obtained by shaping the conductive strips with different lengths within the same gap.

In other examples, conducting surfaces are connected by means of strips with SFC shapes, as illustrated in FIGS. 3, 4, 5, 10, 11, 14, and 15. In these configurations, SFCs can cover more than 50% of the area covered by the ground-plane, as shown in the examples of FIG. 14. In other examples, the gap between the conducting surfaces is shaped as a SFC, as shown in FIG. 12 or 13. In some examples, SFCs feature a box-counting dimension larger than one (at least for an octave in the abscissa of the log-log graph used in the box-counting algorithm) and can approach the so called Hilbert or Peano curves or even some ideally infinite curves known as fractal curves.

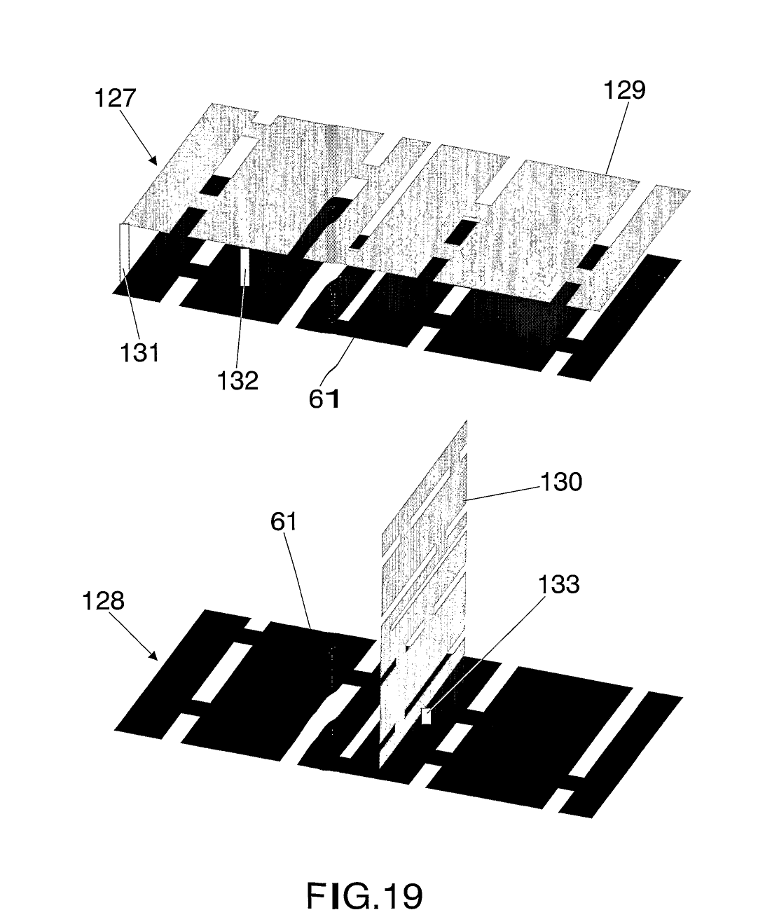

FIG. 19 shows two example antenna structures (127), (128) in which the radiating element (129), (130) is shaped similarly to the multilevel ground-plane (61). In this manner, a symmetrical or quasymmetrical configuration is obtained in which the resonances of the ground-plane (61) and the radiating element (129), (130) combine to enhance the antenna behaviour. FIG. 19 illustrates an example of a microstrip antenna (127) and a monopole antenna (128) using this configuration. The example microstrip antenna (127) includes a short-circuited radiating element (129) with shorting conductor (131), a feeding point (132) and a multilevel ground-plane (61). The monopole antenna (128) includes a radiating element (130), a multilevel ground-plane (61) and a feeding point (133).

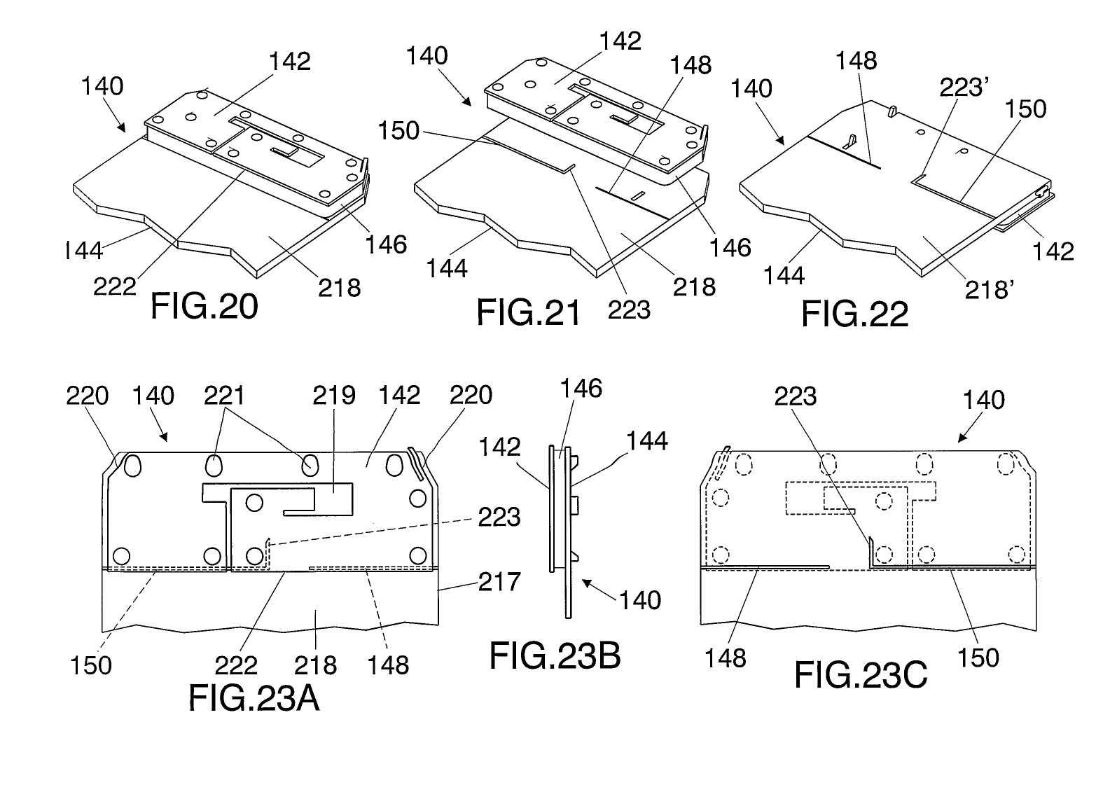

FIGS. 20-23C show an example antenna for a mobile device. With reference first to FIG. 20, the antenna structure (140) includes a radiating element (142) that is connected to a printed circuit board (PCB) (144) using a dielectric mounting structure (146). One of the layers of the PCB (144) includes a multilevel ground-plane (218), as described above. In most instances, the PCB (144) will include a multilayer substrate, wherein the ground-plane is embedded as one of the PCB conducting layers.

FIG. 21 is an exploded view of the example antenna, showing two slots (148), (150) that are cut through one or more layers of the PCB (144). The slots (148), (150) extend at least through a ground-plane layer of the PCB (144), forming a multilevel ground-plane structure having two conducting surfaces that are connected by a conducting strip as previously shown in FIG. 1 (the conducting strip in this example is formed between the two slots (148), (150.) A rear view of the example antenna (140) is provided in FIG. 22, illustrating that the slots (148), (150) extend through each layer of the PCB (144) in this example. More in particular, in this preferred embodiment the printed circuit board (144) is provided with a conducting layer on its upper face in which an upper ground plane (218) is formed. In the lower face of the printed circuit board (144) is provided a lower ground plane (218′). The upper and the lower ground planes may have the same shape as shown in FIGS. 21 and 22, although the width of the slots of one ground plane, may be greater than the width of the slots of the other ground plane.

As shown for instance in FIG. 23a, at least one slot (148), (150) is in contact at one of its ends with the perimetric edge (217) of the ground plane (218). Preferably, the slots (148), (150) are aligned and are substantially parallel to one side of the perimetric edge (217) of the ground plane (218).

In a preferred embodiment, the slots (148), (150) and the edge (222) of the radiating element (142) placed over said slots (148),(150), are substantially straight, and the edge (222) of the radiating element extends over the two slots (148), (150).

As it can be seen for instance on FIG. 21, the slot (150) is provided with a slot segment (223) at one of its ends, so that said slot segment (223) defines an angle, (90° in this case), with respect to said slot (150) and is placed below the radiating element (142).

FIGS. 23A-23C are a schematic view of the antenna illustrating an example alignment of the radiating antenna element (142) and the slots (148), (150) through the multilevel ground-plane. The gaps between the conducting surfaces of the ground-plane (e.g., slots (148), (150) may be substantially aligned with at least one edge of the radiating antenna element (142) in order to improve performance of the antenna (140). Antenna performance may also be improved by including the slots (148), (150) through each layer of the PCB (144). In addition, for a cellular device operating at a typical cellular frequency between 800 MHz and 3000 MHz, antenna performance may be further improved by cutting the slots with a width in the range of about 0.3 mm to about 3 mm.

Antenna performance may also be improved by using the following design constraints. Grounded pads or tracks should not be placed over the slots (148), (150). If the strip formed between the two slots (148), (150) is used to embed a RF transmission line, then the transmission line should be a strip-line, a co-planar line or a buried counter-part of the same. The ground surfaces located between the slots (148), (150) should include vias that ground any multiple ground layers in the PCB. The portions of the antenna that operate within a determined band should be positioned close to the slots (148), (150), such that at least a portion is positioned over the slots (148), (150).

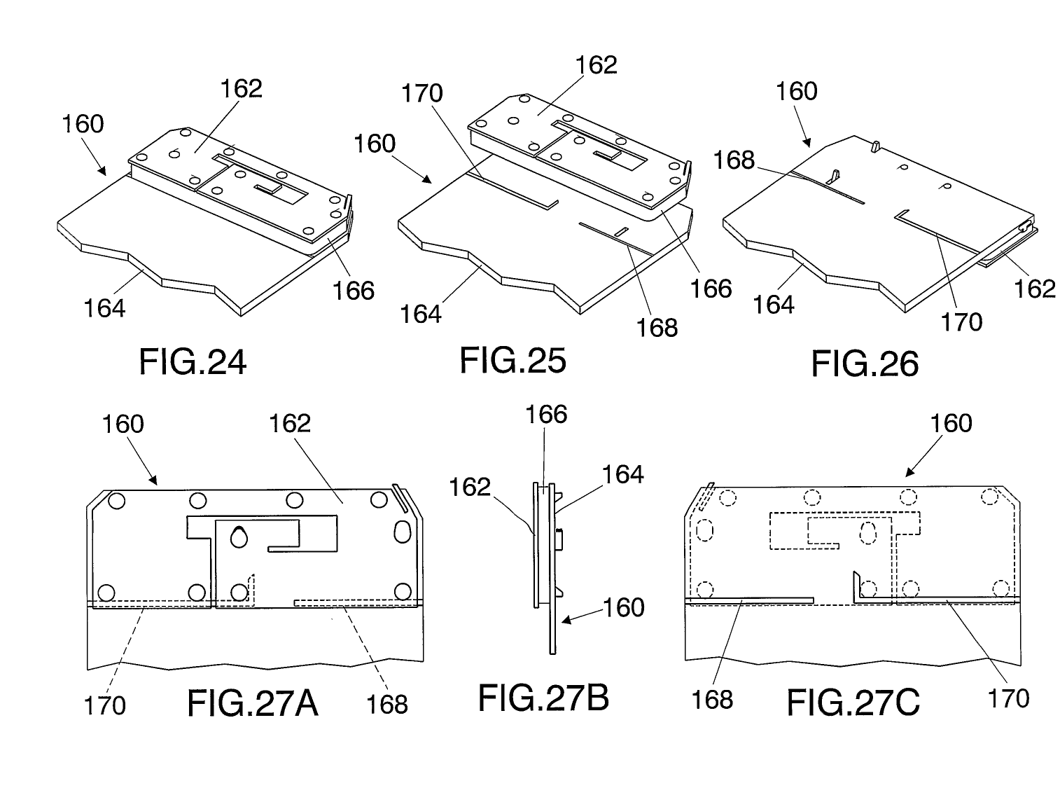

FIGS. 24-27C show another example antenna (160) for a mobile device. This example is similar to the example described above with reference to FIGS. 20-23C, except that the slots (168), (170) in this example are greater in width. Increasing the width of the slots (168), (170) may improve antenna performance.

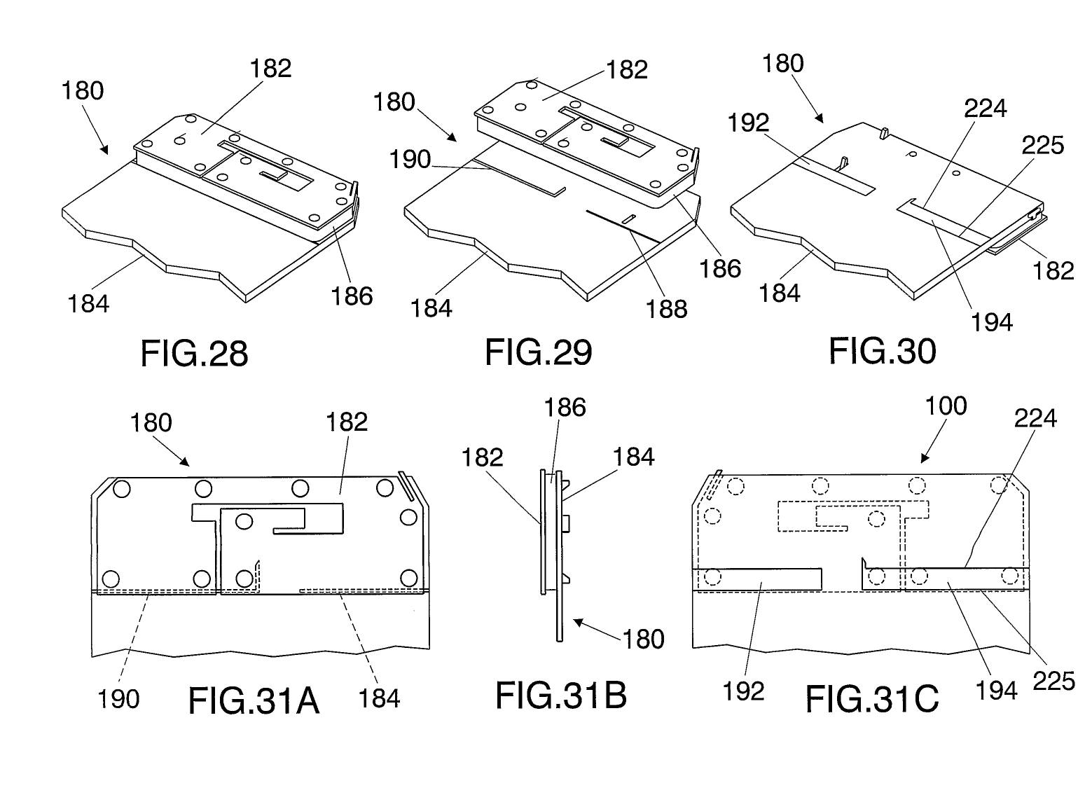

FIGS. 28-310 show a third example antenna (160) for a mobile device. In this example, the slots (188), (190) in the PCB layer closest to the radiating antenna element (182) are smaller in width than the slots (192), (194) in the other layers of the PCB (184). For example, in a cellular device operating at a typical cellular frequency between 800 MHz and 3000 MHz, the slots (188), (190) closest to the radiating antenna element (182) may have a width in the range of about 0.3 mm to about 3 mm, while the slots (192), (194) through other layers of the PCB (184) have a width greater than 3 mm.

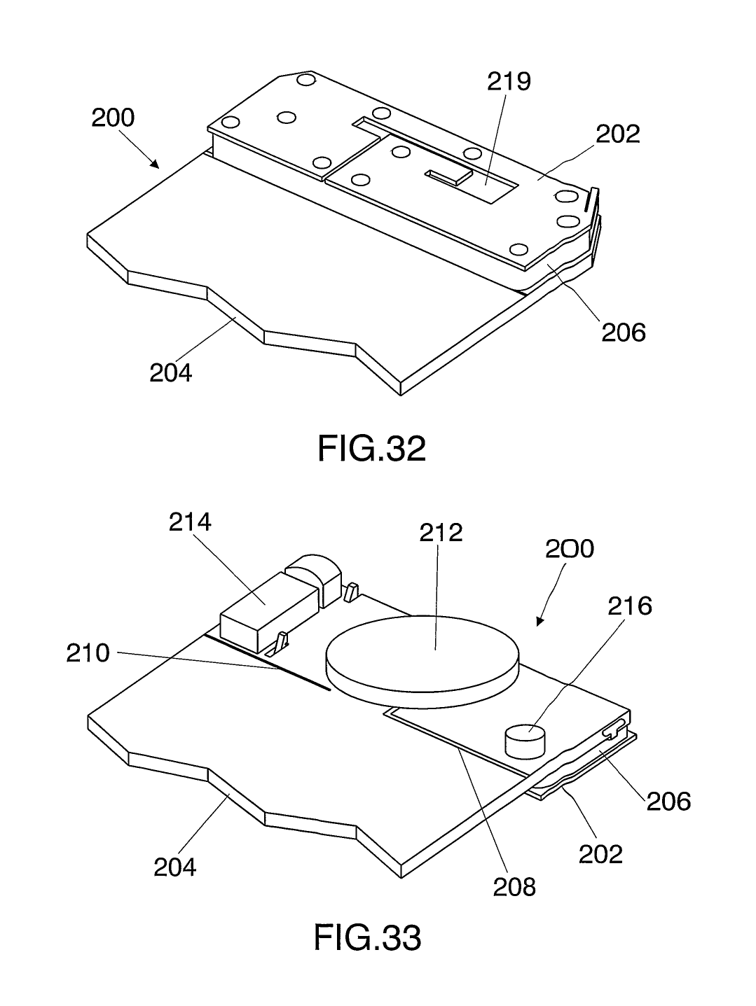

FIGS. 32 and 33 show an example antenna (200) for a mobile device, wherein other mobile device components (212), (214), (216) are mounted on a surface of the PCB opposite the radiating antenna element (202). FIGS. 32 and 33 illustrate that the antenna structure, described herein, conserves space inside a mobile device, possibly enabling other components (212), (214), (216) (e.g., speakers, vibration mechanisms, etc) to be mounted on the PCB (204) opposite an antenna structure.

The invention also refers to an antenna system as shown for instance in FIGS. 20 to 23, which may comprises the ground plane (218) and the radiating element (142) previously described. The radiating element (142) is placed over the ground plane (218), and the radiating element has at least one edge (222) and the ground plane (218) has at least one slot. As shown for instance in FIG. 23a, at least a part of the edge (222) of the radiating element (142) is positioned over a part of one slot of the ground plane (218). More in detail, in the example of FIG. 23a, the entire edge (222) is positioned and extends over the whole length of the slots (148),(150) with the exception of the slot segment (223). With reference now to FIG. 31c, the slots (192),(194) are defined by substantially parallel slot edges (224),(225), and the edge (222) of the radiating element (142) is located over any position within the slot area delimited between said slot edges (224),(225) or it can be even positioned right over one of said edges.

The antenna system of the invention, as shown for instance in FIG. 23a, comprises a radiating element (142) provided with at least one hole (219) which defines a multilevel empty area on said radiating element (142). The shape of said empty area is formed by polygonal shapes connected or overlapping at a contact region of their perimeter, wherein the contact region between directly connected polygonal shapes is narrower than 50% of the perimeter of said polygonal shapes, and wherein the polygonal shapes have the same number of sides but not all the polygonal shapes have the same shape.

Preferably, the polygonal shapes are rectangles, and one of the polygonal shapes may be connected to the perimetric edge of the radiating element (142). In a preferred embodiment, the radiating element (142) is defined by substantially straight edges. The sides of the polygonal shapes may be substantially parallel to at least one side of the radiating element (142) as it can be seen for instance on FIG. 23a. Some of the corners (220) of the radiating element (142) may be cut off in order to facilitate its integration into a communication device. Furthermore, some attachment holes (221) may be provided on the radiating element (142) for its attachment to the dielectric mounting structure (146).

Further embodiments of the invention and particular combinations of features of the invention, are described in the attached claims.

This written description uses examples to disclose the invention, including the best mode, and also to enable a person skilled in the art to make and use the invention. The patentable scope of the invention may include other examples that occur to those skilled in the art. For example, multilevel ground-planes, as described herein, may be used in numerous antenna structures, such as mobile device antennas, base station antennas, car antennas, or other antennas that include a ground-plane.

1. A mobile device, comprising:
a printed circuit board;
an antenna radiating element attached to a surface of the printed circuit board; and
a multilevel ground plane integral with the printed circuit board and electromagnetically coupled to the antenna radiating element;
the multilevel ground plane comprising:
a first conducting surface;
a second conducting surface; and
a conducting strip that couples the first conducting surface to the second conducting surface;
wherein at least a portion of the multilevel ground plane defines a space-filling curve; and
wherein at least one edge of the antenna radiating element is aligned with a slot defined between the first conducting surface and the second conducting surface.

2. An antenna system, comprising a radiating element placed over a ground plane, the radiating element having at least one edge and the ground plane having at least one slot, wherein at least a part of one edge of the radiating element is positioned over a part of one slot of the ground plane.

3. Antenna system according to claim 2 wherein at least one slot is in contact at one of its ends with the perimetric edge of the ground plane.

4. Antenna system according to claim 2 or 3 wherein it comprises two aligned slots which are substantially parallel to one side of the perimetric edge of the ground plane.

5. Antenna system according to claim 4 wherein one edge of the radiating element extends over the two slots.

6. Antenna system according to any of the claims 2 to 5 wherein the slots and the edge of the radiating element placed over said slots, are substantially straight.

7. Antenna system according to any of the claims 2 to 6 wherein a part of at least one of the slot has a constant width, wherein said width is within the range 0.3 mm and 3 mm.

8. Antenna system according to any of the claims 2 to 7 wherein at least one slot has a slot segment at one of its ends, wherein said slot segment defines an angle with respect to said slot.

9. Antenna system according to claim 8 wherein said slot segment is placed below the radiating element.

10. Antenna system according to any of the claims 2 to 9, wherein at least a portion of the radiating element that operates within a determined band is positioned over a part of at least one slot of the ground plane.

11. Antenna system according to any of the claims 2 to 10 wherein it comprises a printed circuit board having at least one conducting layer, and wherein the radiating element is attached to the printed circuit board, and the ground plane is formed on said conducting layers and it is electromagnetically coupled to said radiating element.

12. Antenna system according to claim 11 wherein the ground plane is embedded within the printed circuit board and it is formed in one of its inner conducting layers.

13. Antenna system according to claim 11 or claim 12 wherein the printed circuit board is provided with a conducting layer on its upper and lower faces, wherein a ground plane is formed in each conducting layer.

14. Antenna system according to any of the claims 2 to 13 wherein at least one ground plane comprises two slots which define in the ground plane a first conducting surface, a second conducting surface, and a conducting strip that couples the first conducting surface to the second conducting surface.

15. Antenna system according to claims 13 and 14 wherein the ground planes have the same shape.

16. Antenna system according to claims 13 and 14 wherein the width of the slots of at least one ground plane is greater than the width of the slots of the other ground planes.

17. Antenna system according to claim 16, wherein the width of at least one of the slots of at least one ground plane is greater than 3 mm.

18. Antenna system according to the claims 15 to 17 wherein the at least one ground plane comprising the two slots, further comprises at least one via in the surface located between the said two slots to ground any other ground planes.

19. Antenna system according to any of the claims 16 to 18, wherein no grounded pad and/or grounded track comprised in the said printed circuit board is placed over the slots.

20. Antenna system according to any of the claims 2 to 19, wherein the radiating element comprises at least one hole defining an empty area on said radiating element, wherein the shape of said empty area is formed by polygonal shapes connected or overlapping at a contact region of their perimeter, wherein the contact region between directly connected polygonal shapes is narrower than 50% of the perimeter of said polygonal shapes, and wherein the polygonal shapes have the same number of sides but not all the polygonal shapes have the same shape.

21. Antenna system according to claims 20 wherein the polygonal shapes are rectangles.

22. Antenna system according to claims 20 or claim 21 wherein one of the polygonal shapes is connected to the perimetric edge of the radiating element.

23. Antenna system according to any of the claims 2 to 22 wherein the radiating element is substantially rectangular.

24. Antenna system according to any of the claims 2 to 23, wherein at least one of the corners of the radiating element is cut off in order to facilitate its integration into a communication device.

25. Antenna system according to any of the claims 2 to 24 wherein at least a part of one slot and/or at least a part of the conducting strips connecting two of said conducting surfaces is shaped as a space-filling curve.

26. Antenna system according to any of the claims 2 to 25 wherein at least one of the strips connecting two of said conducting surfaces is shaped as a zigzag or meandering curve.

27. Antenna system according to claim 26 wherein said space-filling curve is composed by at least ten connected segments, wherein said segments are smaller than a tenth of the operating free-space wave length and they are spatially arranged in such a way that none of said adjacent and connected segments form another longer straight segment.

28. Antenna system according to claim 26 or 27 wherein said space-filling features a box-counting dimension larger than one.

29. Antenna system according to any of the claims 2 to 28 wherein at least a portion of the geometry of said ground-plane is a multilevel structure, said multilevel structure including a set of conducting polygons, all of said polygons featuring the same number of sides, wherein said polygons are electromagnetically coupled either by means of a capacitive coupling or ohmic contact, wherein the contact region between directly connected polygons is narrower than 50% of the perimeter of said polygons.

30. Antenna system according to any of the claims 2 to 29 wherein the antenna is a multiband antenna.

31. A mobile communications device comprising an antenna system according to any of the claims 2 to 30.

32. A mobile communications device according to claim 31, wherein the antenna system conserves space inside the said mobile communication device enabling at least one component to be mounted on the printed circuit board opposite to the antenna structure.

33. A mobile communications device according to claim 32, wherein the said at least one component comprises a speaker or a vibration mechanism.

34. A mobile communication device according to any of the claims 31 to 33, wherein the communication device is selected from the group comprising: a cellular telephone, a PDA, a pager.

35. A mobile communications device according to any of the claims 31 to 34, wherein the said mobile communications device operates in at least one typical cellular frequency band between 800 MHz and 3000 MHz.
